(19) United States
(12) Patent Application Publication
(10) Pub. No.: US 2006/0254654 A1
(43) Pub. Date: Nov. 16, 2006

(54) Fuel tank overflow preventer

(76) Inventor: Oren Cotton, Orcas Island, WA (US)

Correspondence Address: Andrew W. Ludy, 17 Sherwood Way, Landing, NJ, 07850, US

(21) Appl. No.: 11/125,628

(22) Filed: May 10, 2005

(51) Int. Cl. F02M 37/00

(52) U.S. Cl. 137/574

(57) ABSTRACT

A fuel tank overflow preventer comprises an overflow tank disposed inside a fuel tank adjacent the roof The overflow tank has a lower hole spaced below an upper hole. The lower and upper holes communicate the overflow tank interior with the fuel tank interior. The overflow tank holes are disposed away from the fuel fill to preclude filling the overflow tank directly from the fuel fill. After filling the fuel tank interior with fuel, the fuel will enter the overflow tank interior through the lower hole at a predetermined rate of flow. This will cause the fuel level in the overflow tank to rise. Conversely, the fuel level in the fuel tank will fall until reaching equilibrium with the overflow tank fuel level. An air space in the fuel tank interior will thereby be established so as to accommodate thermal expansion and prevent spilling of the fuel.

### CROSS-REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

This invention relates to the field of fuel tanks for vehicles, and more particularly to an apparatus and method for preventing fuel from overflowing a fuel tank, especially due to thermal expansion of the fuel.

In the course of filling a fuel tank, especially for a vehicle using gasoline, the fuel will first flood the bottom of the tank, and then the fuel level will rise until it reaches the inlet pipe. Inside the inlet pipe, rising fuel pressure will cause the fuel gun to shut off. Any excess fuel inside the inlet pipe is drained by the inlet overflow tube back to the fuel tank. The fuel source is usually an underground tank, and hence the fuel is relatively cool entering the tank. After fueling, the vehicle fuel tank is subject to ambient air temperatures and sunshine, which causes heating of the fuel and consequent thermal expansion. In the case of a marine vehicle, the expanded fuel will overflow through the fuel tank vent and be discharged overboard. This has environmental, as well as social and economic consequences. Devices and methods for controlling or containing fuel overflow are known and have taken a variety of configurations in the past. Some examples of fuel overflow control and internal chambers are shown in the following patents:

Grigaitis, U.S. Pat. No. 5,894,809; and Diamond, U.S. Pat. No. 5,865,222; each show a chamber surrounding the fill tube that catches overflow fuel and drains the fuel through the fill tube, while venting gases outward. Grigaitis has numerous tubes, fittings, and connections that are expensive to install and subject to leakage. Diamond 222 has limited capacity to accommodate overflowing fuel, and the inlet fuel can fill the chamber completely.

Whitley, U.S. Pat. No. 5,762,093; and Diamond, U.S. Pat. No. 6,167,911; each disclose a valve in the vent tube that permits gases to flow outward, while capturing liquid fuel and directing the fuel back to the tank. Neither Whitley nor Diamond 911 has a chamber to receive overflow fuel.

Langlois, U.S. Pat. No. 5,322,099; Hargest, U.S. Pat. No. 5,229,766; and Hargest, U.S. Pat. No. 4,854,469; each depict an overflow chamber in the vent tube. Langlois 099 requires a removable fill container, which overfills the tank. In all three cases, the extra fuel fills the overflow chamber, leaving no room for expansion. Each reference has numerous tubes, fittings, and connections that are expensive to install and subject to leakage.

Bennett, U.S. Pat. No. 5,975,154; Langlois, U.S. Pat. No. 5,950,688; and Langlois, U.S. Pat. No. 5,727,603; each show a chamber surrounding the fill tube and connected to a vented overflow container. Each has numerous tubes, fittings, and connections that are expensive to install and subject to leakage. Each has valves that can leak or clog.

Shinoda, U.S. Pat. No. 4,178,004; Kleinberg, U.S. Pat. No. 1,419,145; and Potter, U.S. Pat. No. 2,644,514, each disclose a reserve tank inside the fuel tank. The reserve tanks of Potter and Kleinberg are open on top, and valved on the bottom. Shinoda has a valved inlet on top. None of these prior-art devices can handle overflow fuel. Each is intended to be filled completely when the fuel tank is filled.

Accordingly, there is a need to provide a fuel overflow preventer that can prevent fuel overflow upon filling and also in the event of thermal expansion.

There is a further need to provide a fuel overflow preventer of the type described and that is of simple and rugged construction, without valves, fittings, tubes, or connections, so as to be inexpensive and reliable for long service life.

There is a yet further need to provide a fuel overflow preventer of the type described and that will be integral with the fuel tank for simplicity.

There is a still further need to provide a fuel overflow preventer of the type described and that can be manufactured cost-effectively in large quantities of high quality.

### BRIEF SUMMARY OF THE INVENTION

In accordance with the present invention, there is provided a fuel tank overflow preventer, for use in connection with a fuel tank. The fuel tank has an interior and an outer wall, and the outer wall has a roof. The fuel tank has a fuel fill inlet pipe attached to the outer wall and in communication with the fuel tank interior. The fuel tank has an air vent in communication with the fuel tank interior. The overflow preventer comprises an overflow tank juxtaposed with the fuel tank. The overflow tank has an interior, and an upper hole communicating the overflow tank interior with the fuel tank interior adjacent the roof. The overflow tank has a lower hole spaced below the upper hole. The lower hole communicates the overflow tank interior with the fuel tank interior a predetermined distance below the roof. The overflow tank upper hole is disposed away from the fuel fill to preclude filling the overflow tank directly from the fuel fill. Thus, upon filling the fuel tank interior with fuel, the fuel will enter the overflow tank interior through the lower hole at a predetermined rate of flow. This will cause a fuel level in the overflow tank to rise. Conversely, a fuel level in the fuel tank will fall until reaching equilibrium with the overflow tank fuel level. An air space in the fuel tank interior will thereby be established so as to accommodate thermal expansion of the fuel.

### BRIEF DESCRIPTION OF THE SEVERAL VIEWS OF THE DRAWING

A more complete understanding of the present invention may be obtained from consideration of the following description in conjunction with the drawing, in which:

FIG. 1 is a cutaway, perspective view of a fuel tank, having a fuel fill with a fill return connected to the fuel tank, and showing installation of a fuel overflow preventer constructed in accordance with the invention;

FIG. 2 is a cutaway, perspective view of the fuel tank of FIG. 1, showing the fuel overflow preventer of FIG. 1, and having a fill return connected to the overflow preventer;

FIG. 3 is a perspective view of the fuel overflow preventer of FIG. 1;

FIG. 4 is a top view of the fuel overflow preventer of FIG. 1;

FIG. 5 is a sectional, front elevational view of the fuel overflow preventer of FIG. 1, taken along lines 5-5 of FIG. 4;

FIG. 6 is a perspective view of another fuel overflow preventer constructed in accordance with the invention;

FIG. 7 is a top view of the fuel overflow preventer of FIG. 6, taken along lines 8-8 of FIG. 7;

FIG. 8 is a sectional, front elevational view of the fuel overflow preventer of FIG. 6;

FIG. 9 is a cutaway, top view of the fuel tank and fuel overflow preventer of FIG. 1;

FIG. 10 is a sectional, front elevational view of the fuel tank and fuel overflow preventer of FIG. 1, taken along lines 10⁻¹⁰ of FIG. 9, and showing the fuel tank partially full;

FIG. 11 is a sectional, front elevational view of the fuel tank and fuel overflow preventer of FIG. 1, taken along lines 10-10 of FIG. 9, and showing the fuel tank full;

FIG. 12 is a sectional, front elevational view of the fuel tank and fuel overflow preventer of FIG. 1, taken along lines 10-10 of FIG. 9, and showing the fuel tank and fuel overflow preventer full and in equilibrium;

FIG. 13 is a cutaway, perspective view of another fuel tank, having a fuel fill with a fill return connected to the fuel tank, and showing installation of another fuel overflow preventer constructed in accordance with the invention; and

FIG. 14 is a cutaway, perspective view of yet another fuel tank, having a fuel fill with a fill return connected to the fuel tank, and showing installation of yet another fuel overflow preventer constructed in accordance with the invention.

### DETAILED DESCRIPTION OF THE INVENTION

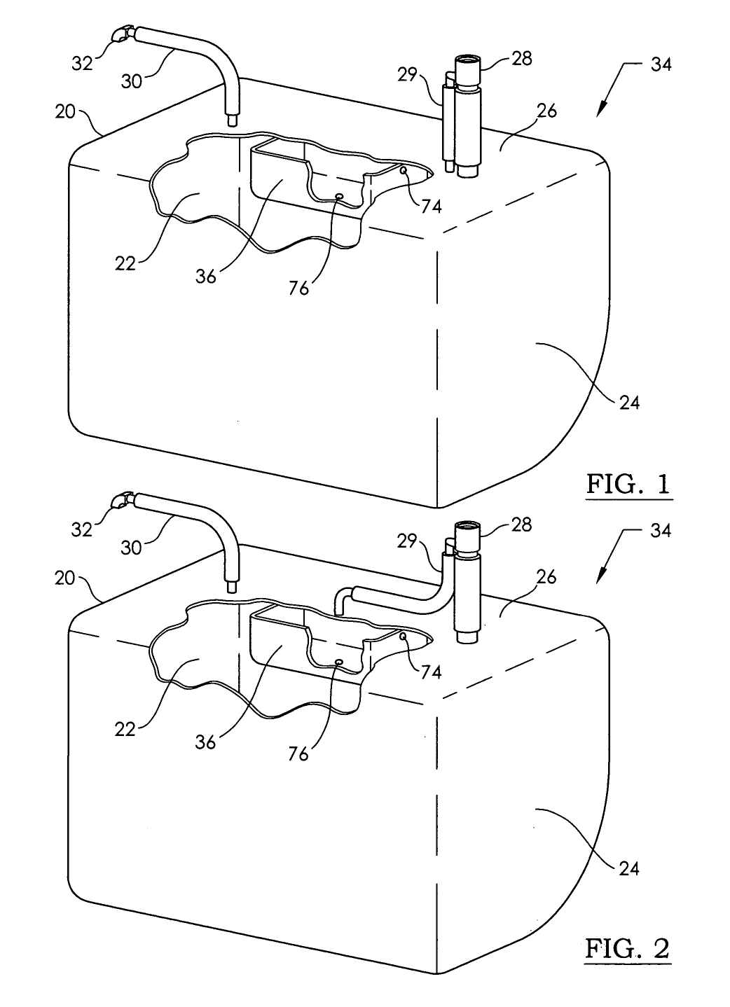

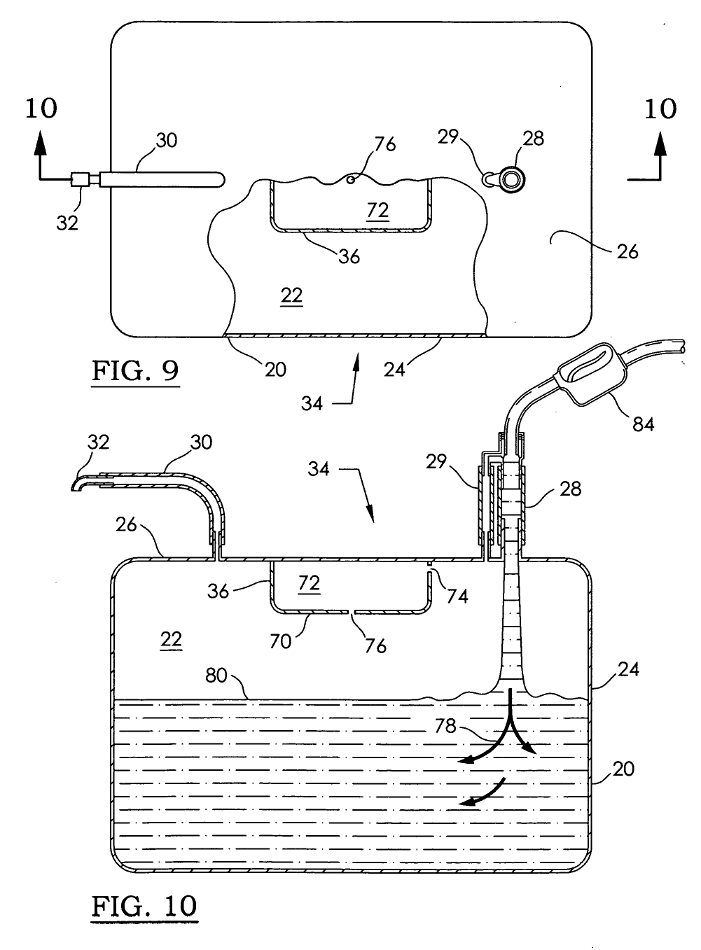

Referring now to the drawing, and especially to FIGS. 1-12 thereof, a fuel tank overflow preventer constructed in accordance with the invention is shown at 34, and is for use in connection with a fuel tank 20, especially a boat fuel tank. The fuel tank 20 has an interior 22 and an outer wall 24, and the outer wall 24 has a roof 26. The fuel tank has an inlet pipe, or fuel fill 28, attached to the outer wall 24 and in communication with the fuel tank interior 22. The marine fuel tank 20 optionally has an air vent in the fill cap (not shown). Another air vent 30 typically communicates the fuel tank interior 22 with an overflow fitting 32 on the side of the boat (not shown) just below the gunwale. This overflow fitting 32 vents displaced air and fumes during filling, and also conveys excess fuel overboard in the event of overfilling. Marine fuel tanks can be constructed of steel, aluminum, fiberglass, or other suitable materials known by those skilled in the art. The overflow preventer 34 comprises an overflow tank 36 juxtaposed with the fuel tank 20. The overflow tank 36 can be constructed of any of the above-described materials, and will typically be made of the same material as the fuel tank 20.

In the preferred embodiment, the overflow tank 36 will be located in the fuel tank interior 22, attached to the fuel tank outer wall 24, on the fuel tank roof 26. The preferred embodiment is shown in FIG. 1, which has a fuel fill overflow drain tube 29 connected back to the fuel tank 20, and in FIG. 2, which has the fuel fill overflow drain tube 27 connected back to the overflow tank 36. Some systems have no fuel fill overflow drain tube.

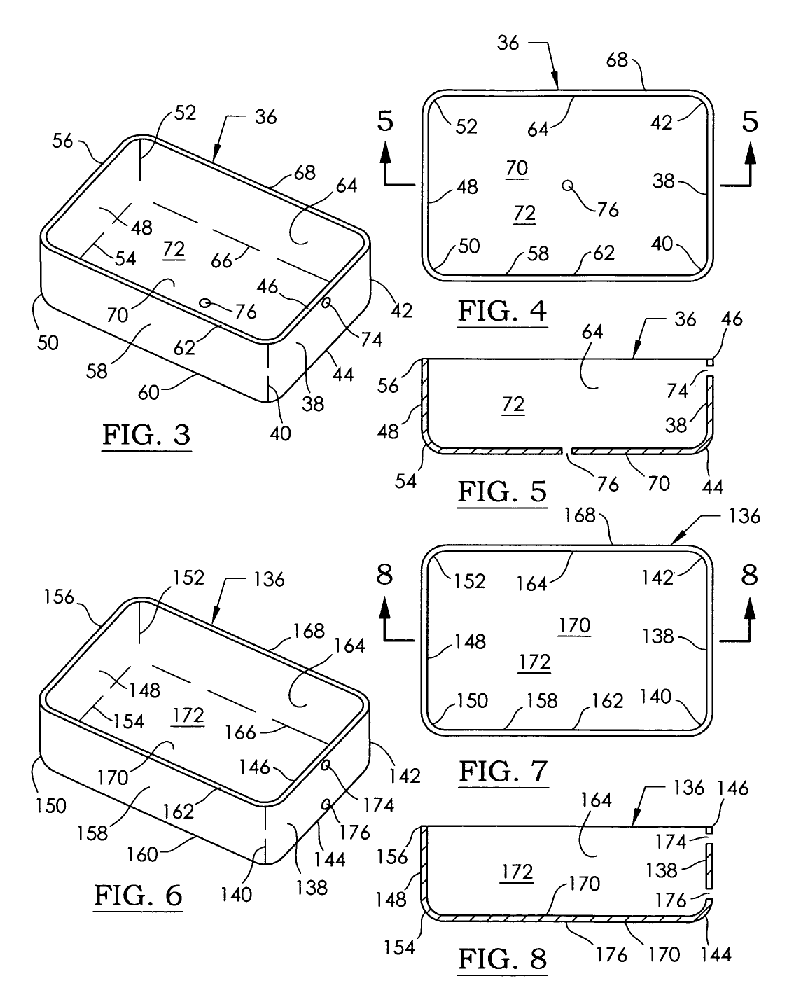

As illustrated in FIGS. 3-5, the overflow tank 36 includes a first end wall 38 extending between front 40 and rear 42 edges and between lower 44 and upper 46 edges. A second end wall 48 is spaced apart from and is generally parallel to the first end wall 38. The second end wall 48 extends between front 50 and rear 52 edges and between lower 54 and upper 56 edges. A front wall 58 extends between the first 40 and second 50 end wall front edges and between lower 60 and upper 62 edges. A rear wall 64 spaced is apart from and is generally parallel to the front wall 58. The rear wall 64 extends between the first 42 and second 52 end wall rear edges and between lower 66 and upper 68 edges. A floor 70 extends between the first 38 and second 48 end walls and between the front 58 and rear 64 walls. The edges and corners are typically radiused as shown, but can be made sharp.

The overflow tank 36 has an interior 72, and an upper hole 74 communicating the overflow tank interior 72 with the fuel tank interior 22 adjacent the roof 26. The upper hole 74 is shown in the end wall 38 closely adjacent the upper edge 46, although it can be in either end wall 38 or end wall 48, or in the front wall 58 or rear wall 64. The overflow tank 36 has a lower hole 76 spaced below the upper hole 74. In this embodiment, the lower hole 76 is in the floor 70. The lower hole 76 communicates the overflow tank interior 72 with the fuel tank interior 22 a predetermined distance below the roof 26. The overflow tank upper hole 74 is disposed away from the fuel fill 28 to preclude filling the overflow tank 36 directly from the fuel fill 28.

Another embodiment of the overflow tank is shown at 136 in FIGS. 6-8. This tank is similar to the overflow tank 36 of FIGS. 3-5 in that it includes a first end wall 138 extending between front 140 and rear 142 edges and between lower 144 and upper 146 edges. A second end wall 148 is spaced apart from and is generally parallel to the first end wall 138. The second end wall 148 extends between front 150 and rear 152 edges and between lower 154 and upper 156 edges. A front wall 158 extends between the first 140 and second 150 end wall front edges and between lower 160 and upper 162 edges. A rear wall 164 spaced is apart from and is generally parallel to the front wall 158. The rear wall 164 extends between the first 142 and second 152 end wall rear edges and between lower 166 and upper 168 edges. A floor 170 extends between the first 138 and second 148 end walls and between the front 158 and rear 164 walls. The edges and corners are typically radiused as shown, but can be made sharp.

The overflow tank 136 has an interior 172, and an upper hole 174 communicating the overflow tank interior 172 with the fuel tank interior 22 adjacent the roof 26. The overflow tank 136 has a lower hole 176 spaced below the upper hole 174. This overflow tank embodiment 136 differs from the tank 36 of FIG. 3 in that the lower hole 176 is shown in the end wall 138 closely adjacent the floor 170, although it can be in either end wall 138 or end wall 148, or in the front wall 158 or rear wall 164. Similarly, the upper hole 174 is shown in the end wall 138 closely adjacent the upper edge 146, although it can be in either end wall 138 or end wall 148, or in the front wall 158 or rear wall 164. As in the previous example, the lower hole 176 communicates the overflow tank interior 172 with the fuel tank interior 22 a predetermined distance below the roof 26. The overflow tank upper hole 174 is disposed away from the fuel fill 28 to preclude filling the overflow tank 136 directly from the fuel fill 128.

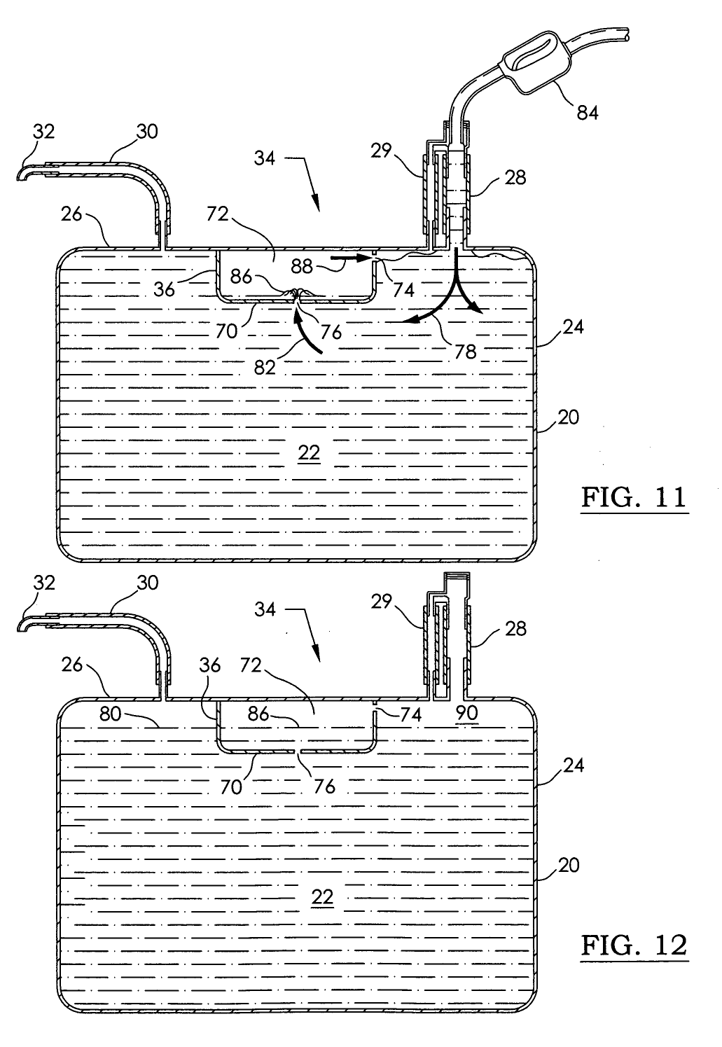

Thus, in the process of filling the fuel tank interior 22 with fuel, shown by inflow arrows 78 in FIG. 10, a fuel level 80 in the fuel tank 20 will rise. As the fuel level 80 rises in the fuel tank 20 past the overflow tank floor 70, the fuel will enter the overflow tank interior 72 through the lower hole 76 at a predetermined rate of flow, as shown by inflow arrow 82 in FIG. 11. The fuel tank fuel level 80 will rise to the roof 26, and partially back up into the fuel fill 28, as depicted in FIG. 11. At this time, a standard fuel filling nozzle, or fuel gun 84, will shut off automatically. Meanwhile, the fuel level 86 in the overflow tank 36 will begin to rise slowly. Conversely, the fuel level 80 in the fuel tank 20 will fall until reaching equilibrium with the overflow tank fuel level 86, as seen in FIG. 12. Displaced air and gases will flow out of the overflow tank interior 72, through the upper hole 74, and into the fuel tank interior 22, as shown by flow arrow 88 in FIG. 11. An air space 90 in the fuel tank interior 22 will thereby be established. Later, as the fuel absorbs heat from the atmosphere and the sun, the fuel will expand into the air space 90 in the fuel tank interior 22 adjacent the roof 26. This air space 90 created by the overflow tank 36 will thereby prevent fuel from spilling overboard upon thermal expansion of the fuel.

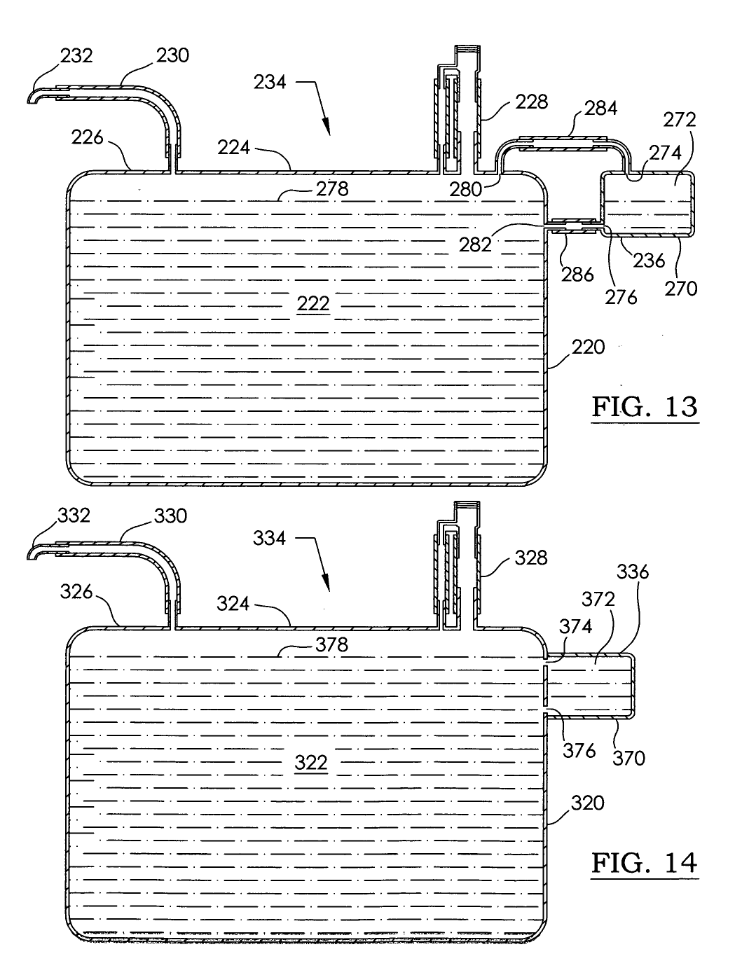

Turning now to FIG. 13, another fuel tank overflow preventer constructed in accordance with the invention is shown at 234, and is for use in connection with a fuel tank 220. The fuel tank 220 has an interior 222 and an outer wall 224, and the outer wall 224 has a roof 226. The fuel tank has a fuel fill 228, attached to the outer wall 224 and in communication with the fuel tank interior 222. An air vent 230 communicates the fuel tank interior 222 with an overflow fitting 232. The overflow preventer 234 comprises an overflow tank 236 juxtaposed with the fuel tank 220.

In this embodiment, the overflow tank 236 is external to the fuel tank 220 and is spaced apart from the fuel tank outer wall 224. The fuel tank 220 includes an upper hole 280 adjacent the roof 226, and a lower hole 282 spaced below the upper hole 280. The overflow tank 236 has an interior 272, and an upper hole 274 communicating the overflow tank interior 272 with the fuel tank interior 222 adjacent the roof 226. The overflow tank 236 has a lower hole 276 spaced below the upper hole 274. the lower hole 76 is closely adjacent the floor 270. The lower hole 276 communicates the overflow tank interior 272 with the fuel tank interior 222 a predetermined distance below the roof 226. The overflow tank upper hole 274 is disposed away from the fuel fill 228 to preclude filling the overflow tank 236 directly from the fuel fill 228. An upper tube 284 communicates the fuel tank upper hole 280 with the overflow tank upper hole 274. Similarly, a lower tube 286 communicates the fuel tank lower hole 282 with the overflow tank lower hole 276.

Referring now to FIG. 14, yet another fuel tank overflow preventer constructed in accordance with the invention is shown at 334, and is for use in connection with a fuel tank 320. The fuel tank 320 has an interior 322 and an outer wall 324, and the outer wall 324 has a roof 326. The fuel tank has a fuel fill 328, attached to the outer wall 324 and in communication with the fuel tank interior 322. An air vent 330 communicates the fuel tank interior 322 with an overflow fitting 332. The overflow preventer 334 comprises an overflow tank 336 juxtaposed with the fuel tank 320.

In this embodiment, the overflow tank 336 is external to the fuel tank 320 and is attached to the fuel tank outer wall 324. The overflow tank 336 has an interior 372, and an upper hole 374 that penetrates the fuel tank outer wall 324. The upper hole 374 communicates the overflow tank interior 372 with the fuel tank interior 322 adjacent the roof 326. The overflow tank 336 has a lower hole 376 spaced below the upper hole 374 and closely adjacent the floor 370. The overflow tank lower hole 376 penetrates the fuel tank outer wall 324. The lower hole 376 communicates the overflow tank interior 372 with the fuel tank interior 322 a predetermined distance below the roof 326. The overflow tank upper hole 374 is disposed away from the fuel fill 328 to preclude filling the overflow tank 336 directly from the fuel fill 328.

Referring again to FIGS. 1-5, and 9-12, an overflow prevention method is also disclosed for preventing fuel from overflowing a fuel tank. The method comprises the steps of providing an overflow tank 36 having an interior 72, then juxtaposing the overflow tank 36 with the fuel tank 20. Next, providing an upper hole 74 in the overflow tank, then disposing the overflow tank upper hole 74 adjacent the fuel tank roof 26, then communicating the overflow tank interior 72 with the fuel tank interior 22 through the upper hole 74. Next, providing a lower hole 76 in the overflow tank 36 spaced below the upper hole 74, then communicating the overflow tank interior 72 with the fuel tank interior 22 through the lower hole 76 a predetermined distance below the roof 26, and disposing the overflow tank upper hole 74 away from the fuel fill 28, thereby precluding filling the overflow tank 36 directly from the fuel fill 28. Next, filling the fuel tank interior 22 with fuel, then allowing the fuel to enter the overflow tank interior 72 through the lower hole 76 at a predetermined rate of flow, and allowing a fuel level 86 in the overflow tank 36 to rise, as the fuel flows from the fuel tank 20 into the overflow tank 36. Next, allowing a fuel level 80 in the fuel tank 20 to fall until reaching equilibrium with the overflow tank fuel level 86, and establishing, thereby, an air space 90 in the fuel tank interior 22. Lastly, accommodating thermal expansion of the fuel within the air space 90.

Turning now to FIG. 13, further steps include disposing the overflow tank 236 external to the fuel tank 220, then spacing the overflow tank 236 apart from the fuel tank outer wall 224, then providing an upper hole 280 in the fuel tank outer wall 224 adjacent the roof 226, then providing a lower hole 282 in the fuel tank outer wall 224 spaced below the upper hole 280. Next, communicating the fuel tank upper hole 280 with the overflow tank upper hole 274 through an upper tube 284, and communicating the fuel tank lower hole 282 with the overflow tank lower hole 276 through a lower tube 286.

Turning now to FIG. 14, yet further steps comprise disposing the overflow tank 336 external to the fuel tank 320, then attaching the overflow tank 336 to the fuel tank outer wall 324, then penetrating the fuel tank outer wall 324 with the overflow tank upper hole 374, and penetrating the fuel tank outer wall 324 with the overflow tank lower hole 376.

Referring once again to FIGS. 1-5, and 9-12, still further steps include disposing the overflow tank 36 in the fuel tank interior 22, then attaching the overflow tank 36 to the fuel tank outer wall 24, and finally attaching the overflow tank 36 to the fuel tank roof 26.

Numerous modifications and alternative embodiments of the invention will be apparent to those skilled in the art in view of the foregoing description. Accordingly, this description is to be construed as illustrative only and is for the purpose of teaching those skilled in the art the best mode of carrying out the invention. Details of the structure may be varied substantially without departing from the spirit of the invention and the exclusive use of all modifications that will come within the scope of the appended claims is reserved.

1. A fuel tank overflow preventer, for use in connection with a fuel tank, the fuel tank having an interior and an outer wall, the outer wall having a roof, the fuel tank having a fuel fill attached to the outer wall and in communication with the fuel tank interior, the fuel tank having an air vent in communication with the fuel tank interior, the overflow preventer comprising an overflow tank juxtaposed with the fuel tank, the overflow tank having an interior, the overflow tank having an upper hole communicating the overflow tank interior with the fuel tank interior adjacent the roof, the overflow tank having a lower hole spaced below the upper hole, the lower hole communicating the overflow tank interior with the fuel tank interior a predetermined distance below the roof, the overflow tank upper hole being disposed away from the fuel fill to preclude filling the overflow tank directly from the fuel fill, so that upon filling the fuel tank interior with fuel, the fuel will enter the overflow tank interior through the lower hole at a predetermined rate of flow, causing a fuel level in the overflow tank to rise, and a fuel level in the fuel tank will fall until reaching equilibrium with the overflow tank fuel level, thereby establishing an air space in the fuel tank interior so as to accommodate thermal expansion of the fuel.

2. The overflow preventer of claim 1, wherein the overflow tank is in the fuel tank interior.

3. The overflow preventer of claim 2, wherein the overflow tank is attached to the fuel tank outer wall.

4. The overflow preventer of claim 3, wherein the overflow tank is attached to the fuel tank roof.

5. The overflow preventer of claim 1, wherein:
the overflow tank is external to the fuel tank and is attached to the fuel tank outer wall;
the overflow tank upper hole penetrates the fuel tank outer wall; and
the overflow tank lower hole penetrates the fuel tank outer wall.

6. The overflow preventer of claim 1, wherein:
the overflow tank is external to the fuel tank and is spaced apart from the fuel tank outer wall;
the fuel tank includes an upper hole adjacent the roof;
the fuel tank includes a lower hole spaced below the upper hole;
an upper tube communicates the fuel tank upper hole with the overflow tank upper hole; and
a lower tube communicates the fuel tank lower hole with the overflow tank lower hole.

7. A fuel tank overflow preventer, for use in connection with a fuel tank, the fuel tank having an interior and an outer wall, the outer wall having a roof, the fuel tank having a fuel fill attached to the outer wall and in communication with the fuel tank interior, the fuel tank having an air vent in communication with the fuel tank interior, the overflow preventer comprising an overflow tank in the fuel tank interior, the overflow tank having an interior, the overflow tank having an upper hole communicating the overflow tank interior with the fuel tank interior adjacent the roof, the overflow tank having a lower hole spaced below the upper hole, the lower hole communicating the overflow tank interior with the fuel tank interior a predetermined distance below the roof, the overflow tank upper hole being disposed away from the fuel fill to preclude filling the overflow tank directly from the fuel fill, so that upon filling the fuel tank interior with fuel, the fuel will enter the overflow tank interior through the lower hole at a predetermined rate of flow, causing a fuel level in the overflow tank to rise, and a fuel level in the fuel tank will fall until reaching equilibrium with the overflow tank fuel level, thereby establishing an air space in the fuel tank interior so as to accommodate thermal expansion of the fuel.

8. The overflow preventer of claim 7, wherein the overflow tank is attached to the fuel tank outer wall.

9. The overflow preventer of claim 8, wherein the overflow tank is attached to the fuel tank roof.

10. The overflow preventer of claim 9, wherein the overflow tank further comprises:
a first end wall extending between front and rear edges and between lower and upper edges;
a second end wall spaced apart from the first end wall, the second end wall extending between front and rear edges and between lower and upper edges;
a front wall extending between the first and second end wall front edges and between lower and upper edges;
a rear wall spaced apart from the front wall, the rear wall extending between the first and second end wall rear edges and between lower and upper edges; and
a floor extending between the first and second end walls and between the front and rear walls.

11. An overflow prevention method for preventing fuel from overflowing a fuel tank, the fuel tank having an interior and an outer wall, the outer wall having a roof, the fuel tank having a fuel fill attached to the outer wall and in communication with the fuel tank interior, the fuel tank having an air vent in communication with the fuel tank interior, the overflow prevention method comprising the steps of:
providing an overflow tank having an interior;
providing an upper hole in the overflow tank;
juxtaposing the overflow tank with the fuel tank;
disposing the overflow tank upper hole adjacent the fuel tank roof;
communicating the overflow tank interior with the fuel tank interior through the upper hole;
providing a lower hole in the overflow tank spaced below the upper hole;
communicating the overflow tank interior with the fuel tank interior through the lower hole a predetermined distance below the roof;
disposing the overflow tank upper hole away from the fuel fill, thereby precluding filling the overflow tank directly from the fuel fill;
filling the fuel tank interior with fuel;
allowing the fuel to enter the overflow tank interior through the lower hole at a predetermined rate of flow;
allowing a fuel level in the overflow tank to rise, as the fuel flows from the fuel tank into the overflow tank;
allowing a fuel level in the fuel tank to fall until reaching equilibrium with the overflow tank fuel level;
establishing, thereby, an air space in the fuel tank interior; and
accommodating thermal expansion of the fuel within the air space.

12. The method of claim 11, further comprising the steps of:
disposing the overflow tank external to the fuel tank;
attaching the overflow tank to the fuel tank outer wall;
penetrating the fuel tank outer wall with the overflow tank upper hole; and
penetrating the fuel tank outer wall with the overflow tank lower hole.

13. The method of claim 11, further comprising the steps of:
disposing the overflow tank external to the fuel tank;
spacing the overflow tank apart from the fuel tank outer wall;
providing an upper hole in the fuel tank outer wall adjacent the roof;
providing a lower hole in the fuel tank outer wall spaced below the upper hole;
communicating the fuel tank upper hole with the overflow tank upper hole through an upper tube; and
communicating the fuel tank lower hole with the overflow tank lower hole through a lower tube.

14. The method of claim 11, further comprising the step of disposing the overflow tank in the fuel tank interior.

15. The method of claim 14, further comprising the step of attaching the overflow tank to the fuel tank outer wall.

16. The method of claim 15, further comprising the step of attaching the overflow tank to the fuel tank roof.
